(19) United States
(12) Patent Application Publication
(10) Pub. No.: US 2025/0354019 A1
(43) Pub. Date: Nov. 20, 2025

(54) PEELABLE COATING COMPOSITION AND USE THEREOF

(71) Applicant: DOW SILICONES CORPORATION, Midland, MI (US)

(72) Inventors: Jinfei WANG, Shanghai (CN); Li DING, Shanghai (CN); Jian CAO, Shanghai (CN); Tao WANG, Shanghai (CN); Linfei WANG, Shanghai (CN); Xiaolian HU, Shanghai (CN)

(21) Appl. No.: 18/874,012

(22) PCT Filed: Jun. 14, 2023
(86) PCT No.: PCT/CN2023/100061

§ 371 Date: Dec. 11, 2024

(30) Foreign Application Priority Data
Jun. 15, 2022 (WO) PCT/CN2022/098853

(51) Int. Cl. C09D 5/20; C09D 133/08

(52) U.S. Cl. CPC C09D 5/20; C09D 133/08

(57) ABSTRACT

A peelable coating composition is provided. The composition may be applied onto a substrate surface and then it dries/cures to a peelable coating. The composition comprises an aqueous vinyl (meth)acrylic-based copolymer emulsion binder in combination with a silicone polyether copolymer and optionally one or more additives. The resulting peelable coating provides temporary protection to articles and/or substrates during a period of construction, storage or transportation or the like, and is designed to be water-resistant such that it is able to continue protecting substrates after periods of time in the open-air, exposed to the elements, e.g., rain, etc. A method is also provided.

This disclosure relates to a peelable coating composition which dries/cures to a peelable coating. The composition comprises an aqueous vinyl (meth)acrylic-based copolymer emulsion binder in combination with a silicone polyether copolymer. The resulting peelable coating provides temporary protection to articles and/or substrates during a period of construction, storage or transportation or the like, and is designed to be water-resistant such that it is able to continue protecting substrates after periods of time in the open-air, exposed to the elements, e.g., rain. In recent years, there has been an increasing demand for peelable coatings that can be applied to a wide range of substrates as described in US8440759, US6822012, US6620890 and CN102850923. Peelable coatings, sometimes alternatively referred to as strippable coatings, are designed to adhere to substrates sufficiently well so that, whilst the coating does not spontaneously peel off from the substrate surface being protected, it remains durable and can be easily peeled off the substrate as and when required without cracking, tearing or breaking the coating in any other way. Hence, they are temporary protective coatings which are removeable by being peeled from the substrate surface after use. The peelable coating compositions need to provide a substrate on to which they have been applied with appropriate physical properties to provide peelable coatings with excellent film properties such as light resistance and thermal stability, whilst also providing chemical and/or physical protection and enabling the coatings to be peeled off in continuous and sizable sheets from the substrate after a period of use.

They are designed to be a cost-effective and time-efficient means for protection of a wide range of substrate surfaces such as metals, plastics, glass and construction materials such as concrete during periods of construction, storage or transportation. Hence, in the case of construction applications such peelable coatings may be used to protect glass such as façade glass, and window glass as well as metal, plastic and/or wooden door frames and window frames and indeed concrete articles etc. during construction whilst being easily removed after construction has been completed. Similarly, peelable coatings may be used to protect vehicles, machine parts, metallic household articles and other ferrous and non-ferrous articles, wooden articles, glass articles, rubber articles, and coated rubber articles during transportation or storage.

They are used, for the sake of example, to protect substrate surfaces from weathering caused by sunlight wind and rain as well as scratches, stains and discoloration damage and/or contamination due to sand, dust, iron powder, salts, alkalis, acids, soot and smoke, insects and bird excrement and the like.

Many commercial peelable coatings require the use of one or more release agents to prevent permanent adhesion of the film to the substrate and to enhance the peelability of the film from the substrate surface onto which it was applied after the period of protection is complete. The industry often prefers to avoid release agents as historically they were often based on materials containing fatty acids which are prone to undergo unwanted reactions with metal and stain masonry and wood. That said it is known that many peelable coatings don't function well after having been subjected to weathering such as after being rained on and then drying out in the sun. Such situations for coatings in exterior situations can lead to a serious loss in coating durability with the coatings cracking and tearing when being removed from the substrate, potentially as a consequence of the coating being too strongly adhered to the substrate surface resulting in an inability to remove the coating by hand. This has been the situation with coatings prepared from peelable coating compositions having one or more binders or film formers (hereafter referred to as “binder(s)”) comprising or consisting of aqueous emulsions or aqueous dispersions.

There is provided herein a peelable coating composition comprising
(a) an aqueous vinyl (meth)acrylic-based copolymer emulsion binder;
(b) a silicone polyether copolymer in an amount of from 0.75 to 10 wt. % of the peelable coating composition selected from one or both of
   (i) RO(C₃H₆O)ₘ (CH₂CH₂O)_{n″}R¹⁵-((CH₃)₂SiO)ₓ (CH₃)₂Si—R¹⁶(OCH₂CH₂)_{n′}(OC₃H₆)_{m′}OR¹, where:
   —R and R¹ may be the same or are different and are each selected from H, or an alkyl group,
   (C₃H₆O) is (CH₂(CH₃)CHO), (CH₂CH₂CH₂O), ((CH₃)CHCH₂O) or mixtures thereof;
   (OC₃H₆) is (OCH₂CH(CH₃)), (OCH₂CH₂CH₂), (OCH(CH₃)CH₂) or mixtures thereof;
   R¹⁵ and R¹⁶ are the same or different and are alkylene groups having from 2 to 6 carbons,
   x is from 2 to about 500, m and m′ may be the same or are different and are each in a range of from 0 to about 50 and n″ and n′ may be the same or are different and are in a range of from 3 to about 50; or

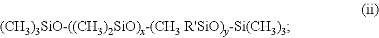

Wherein R′=—R¹⁷—(OCH₂CH₂)_{n′}(OC₃H₆)ₘ′OR;

where R, x, m′, n′ and (OC₃H₆) are the same as above R¹⁷ is an alkylene group having from 2 to 6 carbons, and y is from 1 to about 100; and optionally
(c) one or more additives selected from aqueous solvent, coalescents, defoamers, rheology modifiers, wetting agents plasticisers, pigments and coloring agents and/or a mixture thereof

There is also provided a substrate coated with a temporary peelable coating which coating is the cured/dried product of the above peelable coating composition.

There is also provided a method of forming a peelable coating on a substrate, the method comprising the steps of:
(I′) combining an aqueous vinyl (meth)acrylic-based copolymer emulsion binder (a); with a silicone polyether copolymer (b) in an amount of from 0.75 to 10 wt. % of the peelable coating composition selected from one or both of
(i) RO(C₃H₆O )ₘ (CH₂CH₂O)n″R¹⁵—((CH₃)₂ SiO)ₓ (CH₃)₂Si—R¹⁶—(OCH₂CH₂)_{n′}(OC₃H₆)_{m′}OR¹, where:
—R and R¹ may be the same or are different and are each selected from H, or an alkyl group,
(C₃H₆O) is (CH₂(CH₃)CHO), (CH₂CH₂CH₂O ), ((CH₃)CHCH₂O) or mixtures thereof;
(OC₃H₆) is (OCH₂CH(CH₃)), (OCH₂CH₂CH₂), (OCH(CH₃)CH₂) or mixtures thereof;
R¹⁵ and R¹⁶ are the same or different and are alkylene groups having from 2 to 6 carbons,
x is from 2 to about 500, m and m′ may be the same or are different and are each in a range of from 0 to about 50 and n″ and n′ may be the same or are different and are in a range of from 3 to about 50; or

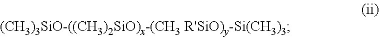

Wherein R′=—R¹⁷—(OCH₂CH₂)_{n′}(OC₃H₆)_{m′}OR;
where R, x, m′, n′ and (OC₃H₆) are the same as above R¹⁷ is an alkylene group having from 2 to 6 carbons, and y is from 1 to about 100; and optionally
one or more additives (c) selected from aqueous solvent, coalescents, defoamers, rheology modifiers, wetting agents plasticisers, pigments and coloring agents and/or a mixture thereof, to form a peelable coating composition,
(II′) applying the peelable coating composition on a substrate surface;
(III′) drying the peelable coating composition applied in step (II′) to form a peelable coating on the substrate surface. The peelable coating resulting from this method is a temporary coating which protects the surface of the substate to which the peelable coating composition has been applied.

There is also provided a substrate coated with a peelable coating obtained or obtainable in accordance with the above process. The substrate coated with a peelable coating is thereby provided with a temporary coating which protects the surface of the substate to which the peelable coating composition has been applied. The peelable coating is removable from the substrate surface by peeling when required.

There is also provided a use of a silicone polyether copolymer (b) in a peelable coating composition in an amount of from 0.75 to 10 wt. % of said peelable coating composition, which silicone polyether copolymer (b) is selected from one or both of

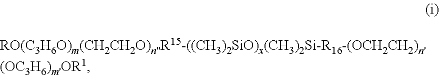

where:
—R and R¹ may be the same or are different and are each selected from H, or an alkyl group,
(C₃H₆O ) is (CH₂(CH₃)CHO), (CH₂CH₂CH₂O), ((CH₃)CHCH₂O) or mixtures thereof;
(OC₃H₆) is (OCH₂CH(CH₃)), (OCH₂CH₂CH₂), (OCH(CH₃)CH₂) or mixtures thereof;
R¹⁵ and R¹⁶ are the same or different and are alkylene groups having from 2 to 6 carbons,
x is from 2 to about 500, m and m′ may be the same or are different and are each in a range of from 0 to about 50 and n″ and n′ may be the same or are different and are in a range of from 3 to about 50; or

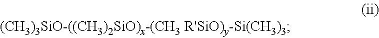

Wherein R′=—R¹⁷—(OCH₂CH₂)_{n′}(OC₃H₆)_{m′}OR;
where R, x, m′, n′ and (OC₃H₆) are the same as above R¹⁷ is an alkylene group having from 2 to 6 carbons, and y is from 1 to about 100; which peelable coating composition otherwise comprises
(a) an aqueous vinyl (meth) acrylic-based copolymer emulsion binder; and optionally
(c) one or more additives selected from aqueous solvent, coalescents, defoamers, rheology modifiers, wetting agents plasticisers, pigments and coloring agents and/or a mixture thereof. For the avoidance of doubt the total wt. % of all ingredients in the composition is 100 wt. %. The term “peelable” is intended to mean that the coating applied onto the substrate as described above is peelable, i.e., removably or temporarily adhered to a substrate. Hence the peelable coating is adhered to the substrate but is removeable therefrom as or when required by peeling the film away from the substrate surface. The use of the term “(meth)” in (meth)acrylates as used throughout the disclosure, is intended to mean acrylates or methacrylates or mixtures thereof.

The peelable coating is a temporary coating provided to protect a substrate surface. It is designed to be water resistant and functions as a protective coating over the substrate onto which it is applied. It is designed to be removeable from the substrate surface by peeling therefrom. Use of the term water-resistant is intended to mean that the peelable coating as described herein is able to resist water penetration to the extent that the peelability and adhesion of the peelable coating to the substrate is not noticeably negatively affected after being exposed to water in the form of rain or the like. It is intended to be used as a means of temporary protection for a period of up to a year but may be used for long term protection if desired.

The components of the peelable coating composition will hereafter be described in more detail.

### Binder (a)

The binder (a) in the above peelable coating composition is an aqueous vinyl (meth)acrylic-based copolymer emulsion.

### Aqueous Vinyl (meth)acrylic-based Copolymer Emulsion

A vinyl (meth)acrylic-based copolymer as herein described may be a random, block or alternating copolymer or a mixture thereof. Standard vinyl (meth)acrylic copolymers are copolymers of vinyl acetate monomer and at least one (meth)acrylate monomer. The (meth)acrylate monomers may include (meth)acrylic acid, C₁-C₂₀-alkyl esters of (meth)acrylic acid, alternatively C₁-C₁₀-alkyl esters of (meth)acrylic acid or C₁-C₈-alkyl esters of (meth)acrylic acid, such as methyl (meth)acrylate, ethyl (meth)acrylate, butyl (meth)acrylate, decyl (meth)acrylate, lauryl (meth)acrylate, isodecyl (meth)acrylate, hydroxyethyl methacrylate, hydroxypropyl methacrylate, 2-ethylhexyl (meth)acrylate, 2-propylheptyl (meth)acrylate, and neopentyl(meth) acrylate or combinations thereof.

A vinyl (meth)acrylic-based copolymer may be made using more than one alkyl (meth)acrylate and may incorporate other organic monomers such as Aryl (meth)acrylate monomers such as phenyl (meth)acrylate and tolyl (meth)acrylate; Aralkyl (meth)acrylate monomers such as benzyl (meth)acrylate and phenethyl (meth)acrylate; Cycloalkyl (meth)acrylate monomers such as cyclohexyl (meth)acrylate, isobornyl (meth)acrylate, 1-adamatyl (meth)acrylate; (meth)acrylamide; (meth)acrylonitrile; ureido-functional monomers such as hydroxyethyl ethylene urea methacrylate; cycloalkyl (meth)acrylates such as cyclohexyl (meth)acrylate, methcyclohexyl acrylate, isobornyl methacrylate, isobornyl acrylate, and dihydrodicyclopentadienyl acrylate; monomers bearing acetoacetate-functional groups such as acetoacetoxyethyl methacrylate (AAEM); monomers bearing carbonyl-containing groups such as diacetone acrylamide (DAAM); vinyl aromatic monomers including styrene and substituted styrene such as alpha-methyl styrene, p-methyl styrene, t-butyl styrene, vinyltoluene, or mixtures thereof; butadiene; α-olefins such as ethylene, propylene, and 1-decene; vinyl acetate, vinyl butyrate, vinyl versatate and other vinyl esters; glycidyl (meth)acrylate; or combinations thereof.

The vinyl (meth)acrylic-based copolymer may alternatively or additionally incorporate silicon containing monomers such as vinyltrialkoxysilanes such as vinyltrimethoxysilane, vinyltriethoxysilane, and vinyltris (2-methoxyethoxy) silane, vinyldimethylethoxysilane, vinylmethyldiethoxysilane, and (meth)acryloxyalkyltrialkoxysilanes such as (meth)acryloxyethyltrimethoxysilane and (meth)acryloxypropyltrimethoxysilane or combinations thereof.

Any suitable combination of the above monomers with a vinyl acetate polymer may be utilised to prepare the vinyl (meth)acrylic-based copolymers herein.

The vinyl (meth)acrylic-based copolymers may be prepared by, for example, emulsion polymerisation which may be initiated/catalysed by thermal, redox (using redox catalysts), photochemical, and electrochemical initiation, however, the polymerisation process is usually initiated/catalysed using one or more conventional free radical initiators for example, peroxides, such as, for example, hydrogen peroxide, sodium or potassium hydroperoxide, t-alkyl peroxides, t-alkyl hydroperoxides e.g. dicumyl hydroperoxide t-amyl hydroperoxide t-butyl hydroperoxide; t-alkyl peresters, wherein the t-alkyl group includes at least 5 carbon atoms; perboric acids and their salts, such as, for example, sodium perborate; perphosphoric acids and salts thereof; ammonium and/or alkali persulfates, potassium permanganate; and ammonium or alkali metal salts of peroxydisulfuric acid. Such initiators may be used in amounts ranging from 0.01 to 3.0 wt. % (weight percent), based on the total weight of monomers.

The vinyl (meth)acrylic-based copolymers herein may be of any suitable weight average molecular weight in the range of from 10,000 to 5,000,000 g/mole, for example from 10,000 to 1,000,000 g/mole, alternatively from 10,000 to 750,000 g/mole). As used herein, unless otherwise indicated, the phrase “molecular weight” with respect to the vinyl (meth)acrylic-based copolymers refers to the weight average molecular weight as measured by gel permeation chromatography (GPC) against polystyrene (PS) standards. The vinyl (meth)acrylic-based copolymers may have any suitable glass transition temperature (Tg) in the range of from −10 to 100° C., for example from −10 to 75° C., or alternatively from −10 to 50° C. As used herein, unless otherwise indicated, the term “Tg” or “glass transition temperature” of a polymer, with regard to the aqueous vinyl (meth)acrylic-based copolymers emulsion and components thereof, refers to the Tg of a polymer calculated by using the Fox equation (T. G. Fox, Bull. Am. Physics Soc., Volume 1, Issue No. 3, page 123 (1956).

Whilst the vinyl (meth)acrylic-based copolymers herein may be made from any suitable combination of (meth)acrylate monomers together with vinyl acetate monomers. Typically, at least 50 wt. % of the monomers are vinyl acetate monomers, alternatively 60 to 90 wt. % of the monomers. The remaining monomers are typically alkyl (meth)acrylate monomers or a combination of alkyl (meth)acrylate monomers and (meth)acrylic acids, aromatic derivatives of (meth)acrylic acid, (meth)acrylamides and acrylonitrile and the like in a wt. % ratio of from 20:1 to 1:1, alternatively from 20:1 to 2.5:1, alternatively from 20:1 to 5.0:1.

If desired, a mixture of vinyl (meth)acrylic-based copolymers may be present with the copolymer (mixture) being an emulsion of liquid in water and/or small polymer particles in water.

When vinyl (meth)acrylic-based copolymer particles are present, they may have an average particle size (diameter) in the range of from 75 to 450 nm, alternatively from 100 to 375nm, alternatively from 115 to 375nm or alternatively from 150 to 300nm. As used herein, unless otherwise indicated, the term “average particle size,” means the particle size as determined by light scattering (LS) using a BI-90 particle size analyzer, Brookhaven Instruments Corp. (Holtsville, N. Y.). Such aqueous vinyl (meth)acrylic-based copolymer emulsions are commercially available from manufacturers such as Dow Chemical Company under the trade names POLYCO™ Emulsions or ROVACE™ Emulsions.

The vinyl (meth)acrylic-based copolymer is present in the peelable coating composition in an amount of from 70 wt. % to 99.25 wt. % of the peelable coating composition.

### Silicone Polyether Copolymer (b)

The silicone polyether copolymer (b) is present in the composition in an amount of from 0.75 to 10 wt. % of the peelable coating composition. It is selected from one or both of
(i) RO(C₃H₆O)ₘ (CH₂CH₂O)_{n″}R¹⁵—((CH₃)₂ SiO)ₓ (CH₃)₂Si—R¹⁶—(OCH₂CH₂)_{n′}(OC₃H₆)_{m′}OR¹, where:
—R and R¹ may be the same or are different and are each selected from H, or an alkyl group,
(C₃H₆O) is (CH₂(CH₃)CHO), (CH₂CH₂CH₂O), ((CH₃)CHCH₂O) or mixtures thereof;
(OC₃H₆) is (OCH₂CH(CH₃)), (OCH₂CH₂CH₂), (OCH(CH₃)CH₂) or mixtures thereof;
R¹⁵ and R¹⁶ are the same or different and are alkylene groups having from 2 to 6 carbons,
x is from 2 to about 500, m and m′ may be the same or are different and are each in a range of from 0 to about 50 and n″ and n′ may be the same or are different and are in a range of from 3 to about 50; or

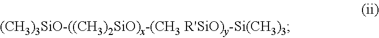

Wherein R′=—R¹⁷—(OCH₂CH₂)_{n′}(OC₃H₆)_{m′}OR;
where R, x, m′, n′ and (OC₃H₆) are the same as above R¹⁷ is an alkylene group having from 2 to 6 carbons, and y is from 1 to about 100.

It will be appreciated that structurally the (C₃H₆O) and (OC₃H₆) units are the same as are
(CH₂(CH₃)CHO) and (OCH(CH₃)CH₂);
(CH₂CH₂CH₂O) and (OCH₂CH₂CH₂); and
((CH₃)CHCH₂O) and (OCH₂CH(CH₃));

In one embodiment the (C₃H₆O) and (OC₃H₆) units are respectively (CH₂(CH₃)CHO) and (OCH(CH₃)CH₂) which may alternatively be referred to as propylene oxide (PO) units and the (CH₂CH₂O) and (OCH₂CH₂) units may alternatively be referred to as ethylene oxide (EO) units.

In the case of alternative (i)
RO(C₃H₆O)ₘ (CH₂CH₂O)_{n″}R¹⁵—((CH₃)₂ SiO)ₓ (CH₃)₂Si—R¹⁶(OCH₂CH₂)_{n′}(OC₃H₆)_{m′}OR¹
R and R¹ may be the same or are different and are each selected from is H, or an alkyl group.

In a most preferred embodiment of alternative (i) (C₃H₆O) is (CH₂(CH₃)CHO) and (OC₃H₆) is (OCH(CH₃)CH₂);

In another embodiment of alternative (i) (C₃H₆O) is (CH₂(CH₃)CHO) and (OC₃H₆) is (OCH₂CH(CH₃).

In a further embodiment of alternative (i) (C₃H₆O) is (CH₂CH₂CH₂O) and (OC₃H₆) is (OCH₂CH₂CH₂).

When one or both of R and R¹ is an alkyl group, the alkyl group may comprise from 1 to 12 carbons, alternatively from 1 to 10 carbons, alternatively from 1 to 6 carbons, alternatively is methyl or ethyl. In one embodiment at least one of R and R¹ is H or a methyl group; alternatively, both R and R¹ is H or a methyl group. In one embodiment both R and R¹ are either H or a methyl group.

R¹⁵, R¹⁶ and R¹⁷ are each alkylene groups having from 2 to 6 carbons. The alkylene groups may be linear or branched but are preferably linear and are for example —(CH₂)ₖ— where k is from 2 to 6, alternatively from 2 to 5, alternatively from 2 to 4, alternatively are —(CH₂)₃— groups. Subscript x is from 2 to 500, alternatively subscript x is from 3 to 450, alternatively subscript x is from 4 to 400, alternatively subscript x is from 5 to 375.

Subscripts m and m′ may be the same or are different and are each selected from 0 to about 50, alternatively one or both of subscripts m and m′ is from 0 to 45, alternatively one or both of subscripts m and m′ is from 0 to 40. In one embodiment both subscripts m and m′ have the same value of from 0 to 40.

Subscript n″ and n′ may be the same or are different and are each selected from 3 to about 50, alternatively each of subscript n″ and n′ is from 3 to 40, alternatively each of subscript n″ and n′ is from 4 to 35, alternatively each of subscript n″ and n′ is from 5 to 30. In one embodiment subscript n″ and n′ are the same and are from 5 to 30.

In one embodiment with respect to alternative (i) of silicone polyether copolymer (b) (i.e. (b)(i)) both R and R¹ are hydrogen, each of m and m′ from 0 to 40 with preferably m and m′ being equal; each of subscript n″ and n′ from 5 to 30 with preferably n″ and n′ being equal and x is from 5 to 375. In such an embodiment preferably R¹⁵ and R¹⁶ are the same and are —(CH₂)₃—

In the case of alternative (ii) is (CH₃)₃SiO—((CH₃)₂SiO)ₓ—(CH₃ R′SiO)_{y}—Si(CH₃)₃;
Wherein R′=—R¹⁷—(OCH₂CH₂)_{n′}(OC₃H₆)_{m′}OR i.e. where Wherein R′=—R¹⁷—(OCH₂CH₂)_{n′}(OCH(CH₃)CH₂)_{m′}OR or
R′=—R¹⁷—(OCH₂CH₂)_{n′}(OCH₂CH(CH₃)_{m′}OR or
R′=—R¹⁷—(OCH₂CH₂)_{n′}(OCH₂CH₂CH₂)_{m′}OR.

Preferably in the case of alternative (ii) R′=—R¹⁷—(OCH₂CH₂)_{n′}(OCH(CH₃)CH₂)_{m′}OR;
where R, R¹⁷, x, m′ and n′ are the same as above, and
y is from 1 to about 100, alternatively y is from 1 to 75 alternatively y is from 1 to 50, alternatively y is from 1 to 40, alternatively y is from 1 to 30, alternatively y is from 1 to 25. In one embodiment for (b)(ii) m′ is from 0 to 45, y is from 1 to 25 and n′ is from 4 to 35. In a preferred embodiment of each of the above R¹⁷ is —(CH₂)₃—

### Additives (c)

The peelable coating composition may additionally comprise one or more additives (c). Additives (c) are all optional and may be selected from aqueous solvent, coalescents, defoamers (otherwise referred to as antifoams or antifoaming agents), rheology modifiers wetting agents, plasticisers, pigments and/or coloring agents and mixtures thereof; alternatively, selected from aqueous solvent, coalescents, defoamers (otherwise referred to as antifoams or antifoaming agents), rheology modifiers wetting agents and mixtures thereof; In one embodiment the peelable coating composition comprises at least one of the additives (c).

### Aqueous Solvent

As discussed previously, binder (a) i.e., the aqueous vinyl (meth)acrylic-based copolymer emulsion comprises an aqueous liquid continuous phase. If desired additional aqueous solvent may be introduced into the peelable coating composition during its preparation but this is not usually necessary. When introduced, this may again be solely water, but it may additionally contain small amounts of other solvents, such as alcohols such as methanol, ethanol, isopropanol, butanol and/or hexanol. When present the additional aqueous solvent is added in an amount of up to 10 wt. % of the peelable coating composition, alternatively up to 5.0 wt. % of the peelable coating composition.

### Coalescents

Optionally the peelable coating composition herein may comprise one or more coalescents to assist in the forming of a continuous peelable coating on the substrate surface. “Coalescents” herein refer to slow-evaporating solvents that fuse polymer particles into a continuous film under ambient condition. The presence of the coalescent(s) herein helps prevent crack formation on the film surface as the peelable coating forms on the substrate surface. The coalescent(s) may include partially hydrophobic organic solvents which are less volatile than water including glycols, ester alcohols and ethers such as butoxydiglycol, butyl glycol, glycol ethyl ether, diethylene glycol ethyl ether, alkylene glycol ethers such as ethylene glycol monomethyl ether, ethylene glycol monohexyl ether, ethylene glycol monoethyl ether, propylene glycol n-butyl ether, ethylene glycol mono-n-butyl ether, diethylene glycol monomethyl ether, diethylene glycol mono-n-butyl ether, propylene glycol monomethyl ether, triethylene glycol monobutyl ether, dipropylene glycol monomethyl ether, tripropylene glycol monomethyl ether, ethylene glycol monoisobutyl ether, diethylene glycol monoisobutyl ether, propylene glycol monoisobutyl ether, ethylene glycol monophenyl ether, propylene glycol monophenyl ether, propylene glycol n-propyl ether, dipropylene glycol n-propyl ether ethylene glycol monomethyl ether acetate, 2-n-butoxyethanol, n-butyl ether and mixtures of any two or more thereof. Preferred coalescents include dipropylene glycol n-butyl ether, ethylene glycol monobutyl ether, diethylene glycol monobutyl ether, n-butyl ether, or mixtures thereof. When present, the coalescents may be present in an amount of up to 12 wt. % of the peelable coating composition, alternatively in an amount of up to 10 wt. % of the peelable coating composition, alternatively in an amount of up to 7.5 wt. % of the peelable coating composition, alternatively in an amount of up to 5.0 wt. % of the peelable coating composition.

### Defoamers

The peelable coating composition may comprise one or more defoamers. “Defoamers” herein refers to chemical additives that reduce and hinder the formation of foam. Defoamers may be ethylene oxide/propylene oxide-based defoamers, silicone-based defoamers including silicone polyethers (SPE), polyoxyalkylene-substituted silicones, silicone alkanolamides, silicone esters and silicone glycosides; mineral oil-based defoamers, alkyl polyacrylates, or mixtures thereof.

A silicone polyether defoamer, when present may have a rake type structure wherein the polyoxyethylene or polyoxyethylene-polyoxypropylene copolymeric units are grafted onto the siloxane backbone, or the SPE can have an ABA block copolymeric structure wherein A represents the polyether portion and B the siloxane portion of an ABA structure. Suitable SPE's include DOWSIL™ OFX-5329 Fluid from Dow Silicones Corporation of Midland, Michigan, USA. When an SPE is used as the defoamer herein, typically it has a hydrophilic-lipophilic balance (HLB) of from about 2 to 3. The defoamer may be an emulsion of a polyether siloxane copolymer in combination with fumed silica such as TEGO™ Airex 902 W supplied by Evonik. For the avoidance of doubt the defoamer is different from component (b) herein.

When present the defoamer can be incorporated into the composition in an amount of up to 2 wt. % of the peelable coating composition, alternatively in an amount of up to 1.5 wt. % of the peelable coating composition alternatively in an amount of up to 1.0 wt. % of the peelable coating composition e.g., in a range of from 0.1 wt. % to 1 wt. % of the peelable coating composition.

### Rheology Modifiers

The peelable coating composition may comprise one or more rheology modifiers, sometimes referred to as thickeners. These may include one or more clay materials, acid derivatives, naturally occurring polymers having e.g., polysaccharide or amino acid building blocks, such as starch, modified starch, proteins, and modified proteins, dimeric and trimeric fatty acids and/or imidazolines. Alternatively, they may comprise polyvinyl alcohol (PVA), acid copolymers, urethane associate thickeners (UAT), polyether urea polyurethanes (PEUPU), polyether polyurethanes (PEPU), alkali swellable emulsions (ASE) such as sodium or ammonium neutralized acrylic acid polymers; hydrophobically modified alkali swellable emulsions (HASE) such as hydrophobically modified acrylic acid copolymers; associative thickeners such as hydrophobically modified ethoxylated urethanes (HEUR); and cellulosic thickeners such as methyl cellulose ethers, hydroxymethyl cellulose (HMC), hydroxyethyl cellulose (HEC), hydrophobically-modified hydroxy ethyl cellulose (HMHEC), styrene-maleic anhydride terpolymer (SMAT), sodium carboxymethyl cellulose (SCMC), sodium carboxymethyl 2-hydroxyethyl cellulose, 2-hydroxypropyl methyl cellulose, 2-hydroxyethyl methyl cellulose, 2-hydroxybutyl methyl cellulose, 2-hydroxyethyl ethyl cellulose, and 2-hydoxypropyl cellulose.

ASE-rheology modifiers are similar in polymer structure to HASE rheology modifiers but do not contain the hydrophobe groupings, i.e., they are dispersions of insoluble acrylic polymers in water which have a high percentage of acid groups distributed throughout their polymer chains. When the acid groups are neutralized, the salt that is formed is ‘hydrated’ the salt either swells in aqueous solutions or becomes completely water soluble. As the concentration of neutralized polymer in an aqueous formulation increases, the swollen polymer chains start to overlap, until they ‘tangle up’. It is this overlapping and tangling that causes viscosity to increase. Again, the concentration of acid groups, the molecular weight and degree of crosslinking of the polymer are important in determining rheology and thickening efficiency. Examples include ACRYSOL™ ASE-75 from Dow. HASE polymers are commercially important as associative rheology modifier type rheology modifiers in aqueous paints and coatings. They are dispersions of water-insoluble acrylic polymers in water which may be rendered water soluble by neutralizing acid groups on the polymer chain and also contain long-chain hydrophobic groups, sometimes referred to as “hydrophobes”. Typically, they are aqueous dispersion of copolymers of
(i) acylate ester or methacrylate ester monomers such as methyl methacrylate ethyl acrylate, butyl acrylate, or ethylhexyl acrylate);
(ii) methacrylic acid, acrylic acid, or itaconic acid; and
(iii) monomers containing long chain hydrophobic groups such as an ethylenically unsaturated polyethylene oxide (polyEO) macromonomer, e.g., an alkylated ethoxylate monomer, preferably an alkylated ethoxylate acrylate or methacrylate.

The alkylated chains may be in the range of C10 to C25, alternatively C12 to C20.

For example, the following commercially available HASEs from the Dow Chemical Company contain polymerized units of ethyl acrylate and methacrylic acid monomers with hydrophobes attached, ACRYSOL™ DR-6600, ACRYSOL™ DR-5500, ACRYSOL™ RM-7 ACRYSOL™ TT-615, ACRYSOL™ DR-72 and ACRYSOL™ TT-935. Other commercially available HASEs include ACRYSOL™ Primal HT-400, ACULYN™M 88, ACULYNTM28, ACULYNL™M 88 and Romax™ 7011 from the Dow Chemical Company, and RHEOTECH™ 4800 from Coatex. Hydrophobe modified ethoxylated urethanes (HEURs) associative rheology modifier type rheology modifiers are widely used in water-borne coatings for their desirable rheological and application properties. The hydrophobically modified alkylene oxide urethane polymer is a polyethylene oxide, polypropylene oxide, or polybutylene oxide urethane polymer, preferably a polyethylene oxide urethane polymer modified with suitable the hydrophobes and may be prepared by e.g., reacting a diisocyanate; a water soluble polyalkylene glycol; and a capping agent comprising the hydrophobe. The hydrophobes are then introduced by end-capping this isocyanate terminated prepolymer with e.g., hydrophobic alcohols or amines. Commercially available HEURs include ACRYSOL™ RM-8W Rheology Modifier and ACRYSOL™ RM-5000 Rheology Modifier both of which are available from the Dow Chemical Company.

Hydroxyethyl cellulose polymers (HEC) are non-ionic, water-soluble polymer that can thicken, suspend, bind, emulsify, form films, stabilize, disperse, retain water, and provide protective colloid action. They are readily soluble in hot or cold water and can be used to prepare solutions with a wide range of viscosities. Examples include Natrosol™ 250 HBR (a water-soluble, non-ionic hydroxyethyl cellulose surface-treated with glyoxal from Ashland Specialty Chemical). Preferably the rheology modifiers chosen when present, are chosen from HECs, HUERs or a mixture thereof.

When present in the peelable coating composition the rheology modifier(s) may be present in an amount of up to 5 wt. % of the peelable coating composition, alternatively of up to 4.0 wt. % of the peelable coating composition alternatively in a range of from 0.01 to 4 wt. % of the peelable coating composition, alternatively from 0.05% to 3%. wt. % of the peelable coating composition.

### Wetting Agents

The peelable coating composition as hereinbefore described may further comprise one or more wetting agents. “Wetting agents” herein refer to chemical additives that reduce the surface tension of a coating composition, causing the peelable coating composition to spread across more easily or penetrate the surface of a substrate. Wetting agents may be polycarboxylates, anionic, zwitterionic, or non-ionic.

Anionic wetting agents may include but are not limited to, alkali metal alkyl sulphates e.g. sodium Lauryl sulfate; Fatty Alcohol Ether Sulfates (FAES); Alkyl Phenol Ether Sulfates (APES); carboxylic, phosphoric and sulfonic acids and their salt derivatives; alkyl carboxylates; acyl lactylates; alkyl ether carboxylates; n-acyl sarcosinate; n-acyl glutamates; fatty acid-polypeptide condensates; alkali metal sulfosuccinates;; sulfonated glycerol esters of fatty acids, such as sulfonated monoglycerides of coconut oil acids; salts of sulfonated monovalent alcohol esters, such as sodium oleylisethionate; amides of amino sulfonic acids, such as the sodium salt of oleyl methyl tauride; sulfonated products of fatty acids nitriles, such as palmitonitrile sulfonate; sulfonated aromatic hydrocarbons, such as sodium alpha-naphthalene monosulfonate; condensation products of naphthalene sulfonic acids with formaldehyde; sodium octahydroanthracene sulfonate; ether sulphates having alkyl groups of 8 or more carbon atoms; alkylarylsulfonates having 1 or more alkyl groups of 8 or more carbon atoms. sodium dodecyl benzene sulfonate, dioctylsulfosuccinate, sodium polyoxyethylene lauryl ether sulfate, diphenyl sulfonate derivatives, e.g., sodium dodecyl diphenyl oxide disulfonate, sodium salt of tert-octylphenoxyethoxypoly(39)ethoxyethyl sulfate.

Anionic wetting agents which are commercially available and useful herein may include but are not limited to, for the sake of example, POLYSTEP™ A4, A7, A11, A15, A15-30K, A16, A16-22, A18, A13, A17, B1, B3, B5, B11, B12, B19, B20, B22, B23, B24, B25, B27, B29, C-OP3S; ALPHA-STEP™ ML40, MC48; STEPANOL™ MG; all produced by STEPAN CO., Chicago, IL; HOSTAPUR™ SAS produced by HOECHST CELANESE; HAMPOSYL™ C30 and L30 produced by W. R. GRACE & CO., Lexington, MA. Silicone polyether wetting agents may include DOWSIL™ OFX-5329 Fluid from Dow Silicones Corporation of Midland, Michigan, USA or BYK-346 commercially available from Byk-Chemie GmbH.

Non-ionic wetting agents include polyethoxylates, such as ethoxylated alkyl polyethylene glycol ethers; polyoxyalkylene alkyl ethers; polyoxyalkylene sorbitan esters; polyoxyalkylene esters;

polyoxyalkylene alkylphenyl ethers, ethoxylated amides; ethoxylated alcohols; ethoxylated esters; polysorbate esters; polyoxypropylene compounds, such as propoxylated alcohols; ethoxylated/propoxylated block polymers and propoxylated esters; alkanolamides; amine oxides; fatty acid esters of polyhydric alcohols, such as ethylene glycol esters, diethylene glycol esters, propylene glycol esters, glyceryl esters, polyglyceryl fatty acid esters, sorbitan esters, sucrose esters and glucose esters. Commercial non-ionic wetting agents include, for the sake of example, TERGITOL™ TMN-6, TERGITOL™ 15S40, TERGITOL™ 15S9, TERGITOL™ 15S12, TERGITOL™ 15S15 and TERGITOL™ 15S20, and TRITON™ X405 produced by The Dow Chemical Company of Midland, Michigan; BRIJ™ 30 and BRIJ™M 35 produced by Croda (UK); MAKON™ 10 produced by STEPAN COMPANY, (Chicago, IL); and ETHOMID™ O/17 produced by Akzo Nobel Surfactants (Chicago, IL).

The wetting agent may alternatively or additionally comprise a silicone polyether (SPE). The silicone polyether as a wetting agent may have a rake type structure wherein the polyoxyethylene or polyoxyethylene-polyoxypropylene copolymeric units are grafted onto the siloxane backbone, or the SPE can have an ABA block copolymeric structure wherein A represents the polyether portion and B the siloxane portion of an ABA structure. Alternatively, the wetting agent may be selected from polyoxyalkylene-substituted silicones, silicone alkanolamides, silicone esters and silicone glycosides. When an SPE is used as the wetting agent herein, typically it has a hydrophilic-lipophilic balance (HLB) of from about 7 to 9 determined by the method described above.

For the avoidance of doubt the SPEs utilised as wetting agents are different from component (b) herein. A commercial example of an SPE wetting agent is BYK-346 commercially available from Byk-Chemie GmbH.

The wetting agent, when present, may be present based on the total weight of the peelable coating composition, in an amount of up to 5 wt. %, alternatively from 0.01 wt. % to 4 wt. % of the peelable coating composition, or alternatively of from 0.1 wt. % to 3 wt. % of the peelable coating composition.

Additives (c) may additionally include plasticisers and/or pigments and coloring agents.

### Plasticisers

Any suitable plasticisers may be incorporated, for example phthalate esters such as di n-octyl phthalate (DOP), di-isononyl phthalate (DINP), di-2-ethylhexyl phthalate (DEHP) and di isodecyl phthalate (DIDP); citrates such as acetyl tributyl citrate (ATBC); adipates such as dioctyl adipate (DOA), di 2-ethylhexyl adipate (DEHA), di isononyl adipate (DINA); and di-isononyl-1,2-cyclohexanedicarboxylate and mixtures thereof.

### Pigments and Colouring Agents

Examples of pigments include titanium dioxide, chromium oxide, bismuth vanadium oxide, iron oxides and mixtures thereof.

Examples of colouring agents for which may be utilized herein include pigments, vat dyes, reactive dyes, acid dyes, chrome dyes, disperse dyes, cationic dyes and mixtures thereof. The pigments and/or coloring agents may be coloured, white, black, metal effect, and luminescent e.g., fluorescent and phosphorescent. Pigments are utilized to colour the composition as required. Any suitable pigment may be utilized providing it is compatible with the composition herein. In two-part moisture cure organopolysiloxane compositions pigments and/or coloured (non-white) fillers e.g., carbon black may be utilized in the catalyst package to colour the end sealant product. Suitable white pigments and/or coloring agents include titanium dioxide, zinc oxide, lead oxide, zinc sulfide, lithophone, zirconium oxide, and antimony oxide.

Suitable non-white inorganic pigments and/or coloring agents include, but are not limited to, iron oxide pigments such as goethite, lepidocrocite, hematite, maghemite, and magnetite black iron oxide, yellow iron oxide, brown iron oxide, and red iron oxide; blue iron pigments; chromium oxide pigments; cadmium pigments such as cadmium yellow, cadmium red, and cadmium cinnabar; bismuth pigments such as bismuth vanadate and bismuth vanadate molybdate; mixed metal oxide pigments such as cobalt titanate green; chromate and molybdate pigments such as chromium yellow, molybdate red, and molybdate orange; ultramarine pigments; cobalt oxide pigments; nickel antimony titanates; lead chrome; carbon black; lampblack, and metal effect pigments such as aluminium, copper, copper oxide, bronze, stainless steel, nickel, zinc, and brass.

Suitable organic non-white pigments and/or coloring agents include phthalocyanine pigments, e.g., phthalocyanine blue and phthalocyanine green; monoarylide yellow, diarylide yellow, benzimidazolone yellow, heterocyclic yellow, DAN orange, quinacridone pigments, e.g., quinacridone magenta and quinacridone violet; organic reds, including metallized azo reds and nonmetallized azo reds and other azo pigments, monoazo pigments, diazo pigments, azo pigment lakes, β-naphthol pigments, naphthol AS pigments, benzimidazolone pigments, diazo condensation pigment, isoindolinone, and isoindoline pigments, polycyclic pigments, perylene and perinone pigments, thioindigo pigments, anthrapyrimidone pigments, flavanthrone pigments, anthanthrone pigments, dioxazine pigments, triarylcarbonium pigments, quinophthalone pigments, and diketopyrrolo pyrrole pigments.

Cumulatively the total amount of additives (c) present in the peelable coating composition may be from 0 (zero) to 19.25 wt. % of the peelable coating composition, alternatively from 0 (zero) to 15.0 wt. % of the peelable coating composition.

The total wt. % of the peelable coating composition described herein is 100wt. % and the total wt. % of additional additives (c) present is the difference between 100 wt. % and the cumulative wt. % of components (a) and (b) of the peelable coating composition.

Hence, there is provided herein a peelable coating composition comprising
(a) an aqueous vinyl (meth)acrylic-based copolymer emulsion binder in an amount of from 70 wt. % to 99.25 wt. % of the peelable coating composition; and
(b) a silicone polyether copolymer in an amount of from 0.75 to 10 wt. % of the peelable coating composition selected from one or both of
(i) RO(C₃H₆O)ₘ (CH₂CH₂O)_{n″}R¹⁵—((CH₃)₂ SiO)ₓ (CH₃)₂Si—R¹⁶(OCH₂CH₂)_{n′}(OC₃H₆)_{m′}OR¹, where: —R and R¹ may be the same or are different and are each selected from H, or an alkyl group,
(C₃H₆O) is (CH₂(CH₃)CHO), (CH₂CH₂CH₂O), ((CH₃)CHCH₂O) or mixtures thereof;
(OC₃H₆) is (OCH₂CH(CH₃)), (OCH₂CH₂CH₂), (OCH(CH₃)CH₂) or mixtures thereof;
R¹⁵ and R¹⁶ are the same or different and are alkylene groups having from 2 to 6 carbons, preferably —(CH₂)₃—; x is from 2 to about 500, m and m′ may be the same or are different and are each in a range of from 0 to about 50 and n″ and n′ may be the same or are different and are in a range of from 3 to about 50; or

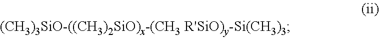

Wherein R′=—R¹⁷—(OCH₂CH₂)_{n′}(OC₃H₆)_{m′}OR;
where R, x, m′, n′ and (OC₃H₆) are the same as above R¹⁷ is an alkylene group having from 2 to 6 carbons, and y is from 1 to about 100. Preferably in the case of alternative (ii) R′—(CH₂)₃ (OCH₂CH₂)_{n′}(OCH(CH₃)CH₂)_{m′}OR; and optionally
one or more additives (c) selected from aqueous solvent, coalescents, defoamers, wetting agents, rheology modifiers, plasticisers, pigments and/or coloring agents and/or a mixture thereof; alternatively one or more additives (c) selected from aqueous solvent, coalescents, defoamers, wetting agents, rheology modifiers, and/or a mixture thereof, in an amount of from 0 (zero) to 19.25 wt. % of the peelable coating composition.

The peelable coating formed after the application of the peelable coating composition, is provided to temporarily protect a substrate surface for a predetermined period of time and then can be removed by being peeled off the substrate surface.

The method for forming the peelable coating on a substrate comprises the steps of:
(I′) combining an aqueous vinyl (meth)acrylic-based copolymer emulsion binder (a); with a silicone polyether copolymer (b) in an amount of from 0.75 to 10 wt. % of the peelable coating composition selected from one or both of
(i) RO(C₃H₆O)ₘ (CH₂CH₂O)_{n″}R¹⁵—((CH₃)₂ SiO)ₓ (CH₃)₂Si—R¹⁶—(OCH₂CH₂)_{n′}(OC₃H₆)_{m′}OR¹, where:
—R and R¹ may be the same or are different and are each selected from H, or an alkyl group, (C₃H₆O) is (CH₂(CH₃)CHO), (CH₂CH₂CH₂O), ((CH₃)CHCH₂O) or mixtures thereof;
(OC₃H₆) is (OCH₂CH(CH₃)), (OCH₂CH₂CH₂), (OCH(CH₃)CH₂) or mixtures thereof;
R¹⁵ and R¹⁶ are the same or different and are alkylene groups having from 2 to 6 carbons,
x is from 2 to about 500, m and m′ may be the same or are different and are each in a range of from 0 to about 50 and n″ and n′ may be the same or are different and are in a range of from 3 to about 50; or

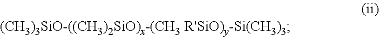

Wherein R′=—R¹⁷—(OCH₂CH₂)_{n′}(OC₃H₆)_{m′}OR;
where R, x, m′, n′ and (OC₃H₆) are the same as above R¹⁷ is an alkylene group having from 2 to 6 carbons, and y is from 1 to about 100. Preferably in the case of alternative (ii) R′=—R¹⁷—(OCH₂CH₂)_{n′}(OCH(CH₃)CH₂)_{m′}OR with R¹⁷ preferably being —(CH₂)₃—; and optionally
one or more additives (c) selected from aqueous solvent, coalescents, defoamers, rheology modifiers, wetting agents, plasticisers, pigments or coloring agents and/or a mixture thereof, to form a peelable coating composition,
(II′) applying the peelable coating composition on a substrate surface;
(III′) drying the peelable coating composition applied in step (II′) to form a peelable coating on the substrate.

The peelable coating composition may be prepared in step (I) of the above in any suitable manner. For example, component (a) may be introduced into a suitable mixer and is then stirred as any optional additives are introduced into the mixture. Subsequent to the addition of any optional additives, the desired amount of the silicone polyether copolymer (b) may be added and is then thoroughly mixed with the other component(s) to ensure the silicone polyether copolymer (b) is consistently dispersed throughout the peelable coating composition. In one embodiment component (a) is stirred in the mixer until all the optional additives are added and then the silicone polyether copolymer (b) was added and was mixed in at 700rpm for a period of up to 10 minutes. Any type of mixing equipment may be used such as Terrell™, Neulander™ or Ross™ mixers or a FlackTek SpeedMixer™ from FlackTek of Landrum, South Carolina, USA.

Once prepared, in step (II′) of the process said peelable coating composition is applied onto a substrate surface by any suitable method, for example it may be spray-applied, brushed, rolled, dipped or otherwise coated onto a substrate although spraying techniques are preferred. Typically, the peelable coating composition is applied as a single layer but, if desired, the peelable coating composition coating can be applied in multiple layers. Typically, the target wet coating thickness of the peelable coating composition on the substrate is from 100μm to 750μm, alternatively a wet coating thickness of from 200 to 700μm, alternatively a wet coating thickness from 250 μm to 600 μm. The wet thickness was determined using a coating bar.

In step (III′) of the process the peelable coating composition is then left to dry/cure to a peelable coating on the substrate surface. The resulting peelable coating is visually clear (see-through). This can be generally completed at room temperature and standard conditions, e.g., atmospheric pressure at 50% relative humidity. Step (III′) can be allowed to take place for anything from 2 to 12 hours, alternatively between 2 and 6 hours.

Substrates to which the peelable coating composition is intended to be applied include materials which are used in construction or are used to protect substrate surfaces during transportation, storage or construction. The peelable coatings formed, after the application of the peelable coating composition, are provided as a temporary means of protection of the materials before use and/or temporarily after use to protect the surface until for example the substrate is ready for use, e.g., after the completion of the construction of a building or once transportation has been completed. The peelable coatings resulting from the peelable coating composition proved to be a temporarily protective coating which is removeable by peeling from substrates to which they were applied without the presence of an intervening layer. The peelable coatings which are temporarily applied to substrate surfaces and are removeable by peeling were peeled away from the substrate surface by hand as a complete film proving that they had a suitable tensile strength given no or minimal fracturing or tearing occurred during the peeling operation even after simulated weathering. Subsequent to the application of the peelable coating on to the substrate the method additionally comprises the step of removing the peelable coating by peeling it off the substrate surface onto which it has been applied.

Hence, there may alternatively be provided with a method of temporarily protecting a substrate by preparing and applying a peelable coating composition as hereinbefore described onto a substrate surface; forming a peelable coating on said substrate, transporting, storing and/or using said substrate in construction; and subsequently removing said peelable coating by peeling same from the substrate surface. In such a process the peelable coating is a temporary removeable coating which is removed by peeling the coating from the substrate surface as and when desired.

While not being tested quantitatively, the fact that the peelable coatings could be removably adhered to the substrates means they also retained a sufficiently low peel strength to enable the act of peeling to be carried out manually by hand. It is the general consensus of the industry that for peelable coatings to be peeled manually the peel strength must be at the very most no more than about 400 N/m, but preferably no more than about 200 N/m and preferably less than about 100 N/m so that the peel strength of the coating to the surface is sufficiently low, and the act of peeling the coating can be carried out by hand manually. Surprisingly it was found that when using silicone polyether copolymers other than component (b) herein, much poorer results were observed such that in many instances the resulting coatings could not be peeled manually or were seen to crack or tear, especially after simulated weathering. These results were determined using the naked eye.

Hence the peelable coatings resulting from application of the peelable coating compositions described herein can be considered to be weather resistant and/or rain resistant and/or waterproof enabling them to be used in both exterior and interior situations. In the case of exterior situations, where the peelable coating composition is applied on an exterior glass, the resulting peelable coating herein may protect exterior facing glass substrates because it has good water resistance, it is not damaged or washed away after exposure to rain even long-term exposure to rain and the peelable coating can then dry but not get damaged, even in the case of direct exposure to the sun, as it remains peelable. Indeed, it would appear to be water resistant because even after harsh testing rain/water fails to affect the peelable performance of the peelable coating.

The peelable coating herein is provided as a protective coating derived from a visually clear (see-through) peelable coating composition which may be applied to a wide range of substrates such as metal, plastic, glass, cloth, ceramic, clay, fiber, concrete, brick, rock or wood. Substrate surfaces may also include painted walls and painted metals.

For example, peelable coating compositions as described herein may be utilised to provide peelable coatings to protect paint, glass, plastic, or metal portions of a vehicle such as an automobile, aeroplane, boat, snowmobile or motorcycle during storage and transportation. Other applications may include temporarily protective coatings for bathroom fixtures, plumbing fixtures, kitchen fittings, white goods such as refrigerators, microwave ovens, plated or chromed parts, instrument panels or the like. The peelable coating may be peeled off the substrate as and when required together with any dirt and contaminants which have impacted the peelable coating during its presence of the substrate surface.

It is particularly designed to provide a peelable coating on interior and exterior glass to provide the glass substrate with a water-resistant protective coating during transportation or construction or the like which can be removed manually as a single film without cracks and/or tears. The glass substrate onto which the peelable coating composition is applied may be virtually any glass substrate for example, borosilicate glass, soda lime glass, silica glass, alkali barium glass, aluminosilicate glass, lead glass, phosphate glass, alkali borosilicate glass, xena glass fluorosilicate glass or a pre-treated glass, for example, vacuum-deposited reflective metallic-coated plate glass which may be used in e.g., commercial building and architectural spandrel applications. It can also protect glass substrates for use in a wide variety of indoor and exterior applications, e.g. in or for optical glass, architectural glass, façade glass, glass for shadow boxes, decorative glass, technical glass, construction glass such as structural glass, float glass, shatterproof glass, laminated glass, extra clean glass, chromatic glass, tinted glass, toughened glass, glass bricks, frosted glass and/or bulletproof glass, elevator glass.glass products such as windows and the like as well as fixtures and fittings for buildings such as bathroom and kitchen fixtures e.g., chrome plated or brass surfaces must be protected not only during shipping, but also during installation or assembly. to avoid scratching and marring before or during construction taking place.

### EXAMPLES

Multiple coating compositions were prepared with a view to comparing their peelability after application on a suitable substrate. An assessment was undertaken to compare their peelability before and after being sprayed with water (simulating rain) with a view to determining the viability of the coatings as peelable coatings for the temporary protection of substrate surfaces which are exposed to the elements during building construction, storage and/or transportation or the like. Several combinations of binders and silicone polyethers were used as the basis for the coating compositions. Six formulations (Formⁿ) were used in which the binder and silicone polyethers were varied as will be seen below. The formulations (Formⁿs) I to VI are depicted in Table 1a.

TABLE 1a
Formulations used in the examples (wt. %)

| | Formⁿ I | Formⁿ II | Formⁿ III | FormⁿIV | Formⁿ V | Formⁿ VI |
|---|---|---|---|---|---|---|
| Binder | 90 | 90 | 90 | 84 | 95 | 95 |
| SPE | 1.0 | 0.5 | 2.0 | 8.0 | 2.0 | 0 |
| Coalescent | 3 | 3 | 3 | 3 | 3 | 3 |
| Defoamer | 0.3 | 0.3 | 0.3 | 0.3 | 0 | 1 |
| Wetting agent | 0.3 | 0.3 | 0.3 | 0.3 | 0 | 1 |
| RM 1 | 1.0 | 1.0 | 1.0 | 1.0 | 0 | 0 |
| RM 2 | 1.0 | 1.0 | 1.0 | 1.0 | 0 | 0 |
| water | 3.4 | 3.9 | 2.4 | 2.4 | 0 | 0 |
| Total | 100 | 100 | 100 | 100 | 100 | 100 |

In Table 1a:

The coalescent used in the examples was TexanolTM Ester Alcohol commercially available from the Eastman Chemical Company.

The defoamer utilised was TEGO™ Airex 902 W commercially available from Evonik Operations GmbH.

The wetting agent used was BYK-346 commercially available from Byk-Chemie GmbH
Rheology Modifier 1 (RM 1) was ACRYSOL™ RM-8W Rheology Modifier commercially available from The Dow Chemical Company.
Rheology Modifier 2 (RM 2) was ACRYSOLTM RM-5000 Rheology Modifier commercially available from The Dow Chemical Company.

The following binders were assessed
Binder 1 was an aqueous vinyl acrylic-based copolymer emulsion commercially sold as ROVACE™ 662 Emulsion by The Dow Chemical Company which is in accordance with the disclosure herein;
Binder 2 was a 100% acrylic polymer emulsion which is a comparative binder sold commercially as ELASTENE™ 3776 Acrylic Emulsion from The Dow Chemical Company;
Binder 3 is a styrene acrylic copolymer emulsion which is a comparative binder sold commercially as PRIMAL™ SF-155 Emulsion; and

Thirteen different silicone polyethers (SPEs) were assessed when in combination with the binders. Some conformed to structure b(i), some to structure b(ii), in each case as described above and others are provided as comparatives. The structures of each of the SPEs are depicted in Table 1b below in which in R²-R¹³ as depicted (EO) is an ethylene oxide unit (OCH₂ CH₂) and (PO) is a propylene oxide unit (OCH (CH₃)CH₂), Ac is an acetate group and Me is a methyl group.

TABLE 1b
Formulae of the silicone polyethers (SPEs) tested herein

| | SPE type | Chemicals |
|---|---|---|
| SPE-1 | b(i) | R²Me₂SiO(Me₂SiO)₁₄Me₂SiR² where R² = —(CH₂)₃(EO)₁₂OH |
| SPE-2 | b(i) | R³Me₂SiO(Me₂SiO)₃₀Me₂SiR³, where R³ = —(CH₂)₃(EO)₂₂(PO)₂₀OH |
| SPE-3 | comp. | Me₃SiO(Me₂SiO)₂₂(MeR⁴SiO)₂SiMe₃, where R⁴ = — (CH₂)₃(EO)₁₂OAc |
| SPE-4 | comp. | Me₃SiO(MeR⁵SiO)SiMe₃, where R⁵ = —(CH₂)₃(EO)₁₂OH |
| SPE-5 | comp. | Me₃SiO(MeR⁶SiO)SiMe₃, where R⁶ = —(CH₂)₃(EO)₈OAc |
| SPE-6 | comp. | Me₃SiO(MeR⁷SiO)SiMe₃, where R⁷ = —(CH₂)₃(EO)₇OMe |
| SPE-7 | comp. | Me₃SiO(MeR⁸SiO)SiMe₃, where R⁸ = —(CH₂)₃(EO)₈OH |
| SPE-8 | comp. | Me₃SiO(Me₂SiO)₁₀₈(MeR⁹SiO)₁₀SiMe₃, |
| | | where R⁹ = —(CH₂)₃(EO)₁₈(PO)₁₈OAc |
| SPE-9 | b(ii) | Me₃SiO(Me₂SiO)₁₄(MeR⁵SiO)₂SiMe₃, |
| SPE-10 | b(ii) | Me₃SiO(Me₂SiO)₆(MeR¹⁰SiO)SiMe₃, where R¹⁰ = —(CH₂)₃(EO)₉(PO)₂₇OH |
| SPE-11 | b(ii) | Me₃SiO(Me₂SiO)₇₈(MeR¹¹SiO)₅SiMe₃, where R¹¹ = —(CH₂)₃(EO)₁₆ OMe |
| SPE-12 | b(ii) | Me₃SiO(Me₂SiO)₃₄₅(MeR¹²SiO)₁₀SiMe₃, |
| | | where R¹² = —(CH₂)₃(EO)₂₅(PO)₃₇OMe |
| SPE-13 | b(ii) | Me₃SiO(Me₂SiO)₂₆₇(MeR¹³SiO)₇SiMe₃, |
| | | where R¹³ = —(CH₂)₃(EO)₆(PO)₁₁OMe |

For the avoidance of doubt, SPEs denoted as comp. are outside this disclosure and are assessed for comparative reasons.

The different compositions were prepared by introducing all ingredients other than the SPE into the binder and stirring for a few minutes in a FlackTek SpeedMixer™ from FlackTek of Landrum, South Carolina, USA at 700 rpm. Subsequently the selected SPE was added and mixing continued for a further 10 minutes again at 700 rpm to ensure the SPE was dispersed uniformly in the composition.

Each resulting composition was then applied onto a glass, ceramic or polyvinylidene fluoride (PVDF) panel (unless otherwise indicated). The wet coating thickness of each applied liquid coating was an average of about 400 μm measured using a coating bar.

The applied liquid coatings were then allowed to dry/cure for about 4 hours at room temperature (RT) and 50% relative humidity.

After drying/curing, the peelability of each coating relative to the substrate on which it was applied was assessed in three ways:
1) At room temperature peelability was tested shortly after completion of the 4 hours drying/curing process;
2) At 5° C. the coated sample underwent drying/curing at a temperature of 5° C. in order to mimic winter temperatures, after which peelability was assessed;
3) After being sprayed with water after curing/drying the coated substrates were put into a suitable laboratory fog box and was sprayed with water for 7 hours to mimic rainy weather. The coated substrates were then dried at 50° C. in an oven, after which the peelability of the peelable coating was assessed. This we believe is a harsher regime than any natural weather the peelable coatings are likely to be exposed to from natural weather even in hot climates such as in the Southeast Asia region.

The peelability of a sample peelable coatings was graded from 1 (worst) to 5 (best) by visually inspecting the peelable coatings for defects such as shrinkage degree after water spray, color change, etc. and comparing with the standard panel. in accordance with the following definitions:
Grade 5: Whole peelable coating is easily peeled off, no residual peelable coating left on the substrate with no splitting cracking during peeling and no damage to substrate.
Grade 4: Almost completely peels off, but slightly more force required. Minimal (5% or less) residue left on the substrate. The peelable coating may have a slight split or crack.
Grade 3: Greater force needed to peel peelable coating from substrate. The peelable coating is more easily torn than (4 or 5 above) and more than 30% residual peelable coating may be left on the substrate.
Grade 2: Can be peeled off, but the peelable coating is easily torn. Greater than 50% of the peelable coating may be left on the substrate and the substrate can be damaged.
Grade 1: Hardly peels off, too good adhesion necessitating solvent or tools to be removed. Table 2 provides an indication of the target grade for each test undertaken. For the avoidance of doubt the symbol ≥ means equal to or greater than.

TABLE 2
Acceptable coating performance in clear coat formulation:

| Performance | Target |
|---|---|
| Peelability at room temperature (RT) on glass | ≥4 |
| Peelability at RT on ceramic | ≥4 |
| Peelability at RT on polyvinylidene fluoride (PVDF) | ≥4 |
| Peelability at 5° C. on glass | ≥4 |
| Peelability at 5° C. on PVDF | ≥4 |
| Peelability after water spraying 7 hrs. then | ≥4 |
| drying at 50° C. overnight (Glass, Ceramic) | |
| Peelability after water spraying 7 hrs. then | ≥3 |
| drying at 50° C. overnight on PVDF | |

TABLE 3a
Peelability results based on the grading scheme above for peelable
coatings at room temperature on several substrates for Ex. 1 to 13

| | | RT | RT | RT |
|---|---|---|---|---|
| | | Results | Results | Results |
| | Composition tested | on glass | on ceramic | on PVDF |
| Ex 1 | Binder 1, SPE-1, Formⁿ I | 4 | 4 | 4 |
| Ex 2 | Binder 1, SPE-2, Formⁿ I | 4 | 4 | 4 |
| Ex 3 | Binder 1, SPE-1, Formⁿ III | 4 | 4 | 4 |
| Ex 6 | Binder 1, SPE-9, Formⁿ I | 4 | 4 | 4 |
| Ex 7 | Binder 1, SPE-10, Formⁿ I | 4 | 4 | 4 |
| Ex 8 | Binder 1, SPE-11, Formⁿ I | 4 | 4 | 4 |
| Ex 9 | Binder 1, SPE-12, Formⁿ I | 4 | 4 | 4 |
| Ex 10 | Binder 1, SPE-13, Formⁿ I | 4 | 4 | 4 |
| Ex. 11 | Binder 1, SPE-1, Formⁿ IV | 4 | 4 | 4 |
| Ex. 12 | Binder 1, SPE-1, Formⁿ V | 4 | 4 | 4 |

TABLE 3b
Peelability results based on the grading scheme above for peelable
coatings at 5° C. and after water spraying for Ex. 1 to 13

| | | | | After water | After water |
|---|---|---|---|---|---|
| | | 5° C. | 5° C. | spraying | spraying |
| | | Results | Results | results | results |
| | Composition tested | on glass | on PVDF | on glass | on PVDF |
| Ex 1 | Binder 1, SPE-1, Formⁿ I | 4 | 4 | 4 | 3 |
| Ex 2 | Binder 1, SPE-2, Formⁿ I | 4 | 4 | 4 | 3 |
| Ex 3 | Binder 1, SPE-1, Formⁿ II | 4 | 4 | 4 | 3 |
| Ex 6 | Binder 1, SPE-9, Formⁿ I | 4 | 4 | 4 | 3 |
| Ex 7 | Binder 1, SPE-10, Formⁿ I | 4 | 4 | 4 | 3 |
| Ex 8 | Binder 1, SPE-11, Formⁿ I | 4 | 4 | 4 | 3 |
| Ex 9 | Binder 1, SPE-12, Formⁿ I | 4 | 4 | 4 | 3 |
| Ex 10 | Binder 1, SPE-13, Formⁿ I | 4 | 4 | 4 | 3 |
| Ex. 11 | Binder 1, SPE-1, Formⁿ IV | 4 | 4 | 4 | 3 |
| Ex. 12 | Binder 1, SPE-1, Formⁿ V | 4 | 4 | 4 | 3 |

It was found that compositions using binder 1 in combination with SPEs in accordance with the definitions herein at an amount of at least 0.75 wt. % provided excellent peelability after water spraying as can be seen in Table 3b. The results above show that even after the water spray testing and drying, the peelable coating remain both peelable by hand and durable, in that they do not tear during peeling after being subjected to the water spray testing. Furthermore, this peelability additionally shows that the peelable coatings preserve sufficient adhesion capabilities after exposure to the water spray which simulated rain.

Several comparative examples were also undertaken using the same test methods and means of assessment. The results are depicted in Tables 4a and 4b.

TABLE 4a
Peelability results based on the grading scheme above for comparative
coatings at room temperature on several substrates

| | | RT | RT | RT |
|---|---|---|---|---|
| | | Results | Results | Results |
| | Comments | on glass | on ceramic | on PVDF |
| C. 1 | Binder 1, SPE-1, Formⁿ II | 3 | 3 | 2 |
| C. 2 | Binder 2, SPE-1, Formⁿ V | 2 | 3 | 1 |
| C. 3 | Binder 3, SPE-1, Formⁿ I | 2 | 3 | 1 |
| C. 4 | Binder 1, SPE-3, Formⁿ I | 4 | 4 | 2 |
| C. 5 | Binder 1, SPE-4, Formⁿ I | 4 | 4 | 2 |
| C. 6 | Binder 1, SPE-5, Formⁿ I | 4 | 4 | 2 |
| C. 7 | Binder 1, SPE-6, Formⁿ I | 4 | 4 | 2 |
| C. 8 | Binder 1, SPE-7, Formⁿ I | 4 | 4 | 2 |
| C. 9 | Binder 1, SPE-8, Formⁿ I | 4 | 4 | 2 |
| C. 10 | Binder 1, Formⁿ VI | 2 | 3 | 1 |
| C. 11 | Binder 1, Formⁿ VI | 2 | 3 | 1 |

TABLE 4b
Peelability results based on the grading scheme above for
comparative coatings at 5° C. and after water spraying

| | | | | After water | After water |
|---|---|---|---|---|---|
| | | 5° C. | 5° C. | spraying | spraying |
| | | Results | Results | results | results |
| | Comments | on glass | on PVDF | on glass | on PVDF |
| C. 1 | Binder 1, SPE-1, Formⁿ II | 2 | 2 | 1 | 0 |
| C. 2 | Binder 2, SPE-1, Formⁿ V | 2 | 1 | 1 | 0 |
| C. 3 | Binder 3, SPE-1, Formⁿ I | 2 | 1 | 1 | 0 |
| C. 4 | Binder 1, SPE-3, Formⁿ I | 4 | 2 | 2 | 1 |
| C. 5 | Binder 1, SPE-4, Formⁿ I | 4 | 2 | 3 | 1 |
| C. 6 | Binder 1, SPE-5, Formⁿ I | 4 | 2 | 2 | 1 |
| C. 7 | Binder 1, SPE-6 Formⁿ I | 4 | 2 | 2 | 1 |
| C. 8 | Binder 1, SPE-7, Formⁿ I | 4 | 2 | 2 | 1 |
| C. 9 | Binder 1, SPE-8, Formⁿ I | 4 | 2 | 2 | 1 |
| C. 10 | Binder 1, Formⁿ VI | 2 | 1 | 2 | 1 |
| C. 11 | Binder 1, Formⁿ VI | 2 | 1 | 2 | 1 |

The results depicted in Tables 4a and 4b were obtained using compositions outside the scope of this disclosure. It can be seen that they gave significantly inferior peelability results based on the grading scheme identified above. C. 1-9 all comprise SPEs outside the required formulation and C. 10 and C. 11 contained no SPE at all. Many of such coatings are no longer durable for the required use, particularly on PVDF and crack and/or tear when attempts are made to peel by hand especially after the extreme water spray testing followed by drying. This led to the conclusion that such peelable coatings would not be fit for purpose which is indicated from the results of Tables 4a and especially 4b.

1. A peelable coating composition comprising:
(a) an aqueous vinyl (meth)acrylic-based copolymer emulsion binder; and
(b) a silicone polyether copolymer in an amount of from 0.75 to 10 wt. % of the peelable coating composition and selected from one or both of (i) and (ii): 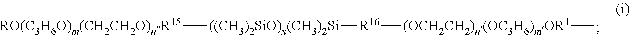
where R and R¹ may be the same or are different and are each selected from H or an alkyl group; (C₃H₆O) is (CH₂(CH₃)CHO), (CH₂CH₂CH₂O), ((CH₃)CHCH₂O) or mixtures thereof; (OC₃H₆) is (OCH₂CH(CH₃)), (OCH₂CH₂CH₂), (OCH(CH₃)CH₂) or mixtures thereof; R¹⁵ and R¹⁶ are the same or different and are alkylene groups having from 2 to 6 carbons, x is from 2 to about 500, m and m′ may be the same or are different and are each in a range of from 0 to about 50 and n″ and n′ may be the same or are different and are in a range of from 3 to about 50; 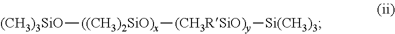
where R′ is —R¹⁷—(OCH₂CH₂)_{n′}(OC₃H₆)_{m′}OR; where R, x, m′, n′ and (OC₃H₆) are the same as above, R¹⁷ is an alkylene group having from 2 to 6 carbons, and y is from 1 to about 100;
and optionally further comprising:
(c) one or more additives selected from aqueous solvent, coalescents, defoamers, rheology modifiers, wetting agents, plasticisers, pigments and coloring agents and/or a mixture thereof.

2. The peelable coating composition in accordance with claim 1, wherein the silicone polyether copolymer (b) (i) is included and has the formula; 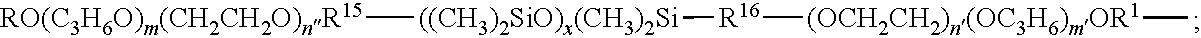
where R and R¹ are hydrogen, m and m′ are the same or different and are from 0 to 40, n″ and n′ are the same or different and are from 5 to 30, and x is from 5 to 375.

3. The peelable coating composition in accordance with claim 1, wherein the silicone polyether copolymer (b)(i) is included and has the formula: 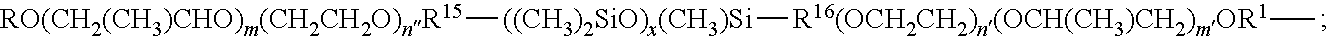
where R and R¹ are hydrogen, R¹⁵ and R¹⁶ are the same or different and are alkylene groups having from 2 to 6 carbons, m and m′ are the same or different and are from 0 to 40, n″ and n′ are the same or different and are from 5 to 30, and x is from 5 to 375.

4. The peelable coating composition in accordance with claim 1, of wherein the silicone polyether copolymer (b)(ii) is included and has the formula: 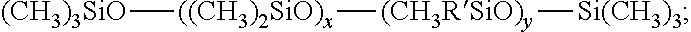
where R′ is —R¹⁷—(OCH₂CH₂)_{n′}(OC₃H₆))_{m′}OR; where R¹⁷ is an alkylene group having from 2 to 6 carbons, R is H or an alkyl group, m′ is from 0 to 45, x is from 2 to about 500, y is from 1 to 25, and n′ is from 4 to 35.

5. The peelable coating composition in accordance with claim 4, wherein the silicone polyether copolymer (b)(ii) has the formula: 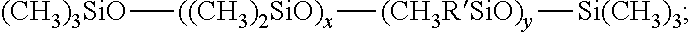
wherein R′ is-R¹⁷—(OCH₂CH₂)_{n′}(OCH(CH₃)CH₂)_{m′}OR; where R¹⁷ is an alkylene group having from 2 to 6 carbons, R is H or an alkyl group, m′ is from 0 to 45, x is from 2 to about 500, y is from 1 to 25, and n′ is from 4 to 35.

6. The peelable coating composition in accordance with claim 1, wherein component (a) is present in the amount of from 70 wt. % to 99.25 wt. % of the peelable coating composition, and optionally wherein the additive(s) of component (c), when present, is/are cumulatively present in an amount of up to 19.25 wt. % of the peelable coating composition.

7. The peelable coating composition in accordance with claim 1, wherein at least one additive (c) is present in the composition.

8. The peelable coating composition in accordance with claim 1, wherein R¹⁵, R¹⁶ and R¹⁷ are —(CH₂)₃— and/or the additive(s) (c) is/are present and selected from aqueous solvent, coalescents, defoamers, rheology modifiers, wetting agents, and/or a mixture thereof.

9. A substrate coated with a peelable coating which is the cured product of the peelable coating composition in accordance with claim 1.

10. A method of forming a peelable coating on a substrate, the method comprising the steps of:
(I) combining (a) an aqueous vinyl (meth)acrylic-based copolymer emulsion binder with (b) a silicone polyether copolymer to form a peelable coating composition, the silicone polyether copolymer (b) present in an amount of from 0.75 to 10 wt. % of the peelable coating composition and selected from one or both of (i) and (ii): 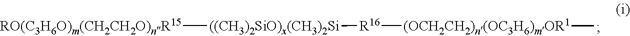
where R and R¹ may be the same or are different and are each selected from H or an alkyl group; (C₃H₆O) is (CH₂ (CH₃)CHO), (CH₂CH₂CH₂O), ((CH₃)CHCH₂O) or mixtures thereof; (OC₃H₆) is (OCH₂CH(CH₃)), (OCH₂CH₂CH₂), (OCH(CH₃)CH₂) or mixtures thereof; R¹⁵ and R¹⁶ are the same or different and are alkylene groups having from 2 to 6 carbons, x is from 2 to about 500, m and m′ may be the same or are different and are each in a range of from 0 to about 50 and n″ and n′ may be the same or are different and are in a range of from 3 to about 50; 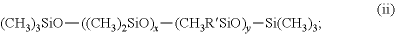
where R′ is —R¹⁷—(OCH₂CH₂)_{n′}(OC₃H₆)_{m′}OR; where R, x, m′, n′ and (OC₃H₆) are the same as above, R¹⁷ is an alkylene group having from 2 to 6 carbons, and y is from 1 to about 100; and optionally further comprising:
(c) one or more additives selected from aqueous solvent, coalescents, defoamers, rheology modifiers, wetting agents, plasticisers, pigments and coloring agents and/or a mixture thereof;
(II′) applying the peelable coating composition on a substrate surface; and
(III′) drying the peelable coating composition applied in step (II′) to form a peelable coating on the substrate surface.

11. The method in accordance with claim 10, wherein R¹⁵, R¹⁶ and R¹⁷ are —(CH₂)₃— and/or the additive(s) (c) is/are present and selected from aqueous solvent, coalescents, defoamers, rheology modifiers, wetting agents, and/or a mixture thereof.

12. The method in accordance with claim 10, wherein the wet coating thickness of the peelable coating composition once applied onto the substrate is from 100 μm to 750 μm measured using a coating bar

13. The method in accordance with claim 11, wherein the substrate is metal, plastic, glass, cloth, ceramic, clay, fiber, concrete, brick, rock, or wood, or painted walls or painted metals.

14. The method in accordance with claim 11, further comprising the step of:
(IV′) removing the peelable coating by peeling it off the substrate surface onto which it has been applied.

15. A substrate coated with a peelable coating obtained or obtainable using the method in accordance with claim 11.

16. (canceled)

17. (canceled)

18. The peelable coating composition in accordance with claim 6, wherein at least one additive (c) is present in the composition.

19. The peelable coating composition in accordance with claim 1, wherein R¹⁵, R¹⁶ and R¹⁷ are —(CH₂)₃—.

20. The method in accordance with claim 10, where R¹⁵, R¹⁶ and R¹⁷ are —(CH₂)₃—.
